(19) United States
(12) Patent Application Publication
(10) Pub. No.: US 2025/0135396 A1
(43) Pub. Date: May 1, 2025

(54) GAS RECOVERY SYSTEM

(71) Applicant: DENSO CORPORATION, Kariya-city (JP)

(72) Inventors: Nobuhiko MATSUDA, Kariya-city (JP); Hidenori ECHIZEN, Kariya-city (JP); Hiroshi KATO, Kariya-city (JP); Shota KINOSHITA, Nisshin-City (JP); Hironori TATSUMI, Nisshin-City (JP)

(21) Appl. No.: 19/009,379

(22) Filed: Jan. 3, 2025

Related U.S. Application Data
(63) Continuation of application No. PCT/JP2023/023893, filed on Jun. 28, 2023.

(30) Foreign Application Priority Data
Jul. 6, 2022 (JP) 2022-109070

(51) Int. Cl. B01D 53/32; B01D 53/62; C01B 32/50

(52) U.S. Cl. CPC B01D 53/326; B01D 53/62; C01B 32/50; B01D 2257/504

(57) ABSTRACT

An electrochemical cell is configured by laminating a working electrode, a counter electrode, a separator, a working electrode collector material and a counter electrode current collector. The working electrode adsorbs the gas to be recovered. The counter electrode transfers electrons to and from the working electrode. The separator is disposed between the working electrode and the counter electrode to prevent physical contact between the working electrode and the counter electrode to suppress electrical shorts from occurring. The working electrode current collector contacts the working electrode and electrically connects the working electrode to the counter electrode. The counter electrode current collector contacts the counter electrode and electrically connects the working electrode to the counter electrode. The counter electrode sealing member is disposed to cover the counter electrode and the counter electrode current collector with respect to the electrochemical cell to suppress contact between the mixed gas and the counter electrode.

### CROSS-REFERENCE TO RELATED APPLICATION

This application is the U.S. bypass application of International Application No. PCT/JP2023/023893 filed on Jun. 28, 2023 which designated the U.S. and claims priority to Japanese Patent Application No. 2022-109070 filed on Jul. 6, 2022, the contents of both of which are incorporated herein by reference.

### TECHNICAL FIELD

The present disclosure relates to a gas recovery system for recovering a gas to be recovered from a mixed gas containing a gas to be recovered.

### BACKGROUND

JP 2018-533470 A discloses a carbon dioxide recovery system that recovers carbon dioxide, a gas to be recovered, from a mixture of gases containing carbon dioxide. The carbon dioxide recovery system of the JP 2018-533470 A is equipped with an electrochemical cell that adsorbs carbon dioxide through an electrochemical reaction.

Each electrochemical cell is formed as a laminate of a flat-shaped working electrode, a counter electrode, a working electrode current collector, a counter electrode current collector, etc. The working electrode contains a carbon dioxide adsorbent that absorbs carbon dioxide from the mixed gas. The counter electrode contains an electroactive auxiliary material that transfers electrons to and from the working electrode. The working electrode current collector is an electrode in contact with the working electrode. The counter electrode current collector is an electrode in contact with the counter electrode.

### SUMMARY

A gas recovery system according to one aspect of the present disclosure is a gas recovery system that recovers a gas to be recovered from a mixed gas by electrochemical reaction, and includes an electrochemical cell and a counter electrode sealing member.

The electrochemical cell is configured by laminating a working electrode, a counter electrode, a separator, a working electrode current collector, and a counter electrode current collector. The working electrode adsorbs the gas to be recovered. The counter electrode transfers electrons to and from the working electrode. The separator is disposed between the working electrode and the counter electrode to prevent physical contact between the working electrode and the counter electrode to suppress electrical shorts from occurring. The working electrode current collector contacts the working electrode and electrically connects the working electrode to the counter electrode. The counter electrode current collector contacts the counter electrode and electrically connects the working electrode to the counter electrode. The counter electrode sealing member is disposed to cover the counter electrode and the counter electrode current collector with respect to the electrochemical cell and suppresses contact between the mixed gas and the counter electrode. The counter electrode sealing member is composed of a film member formed of a material that is impermeable to the mixed gas. A plurality of holes penetrating the separator are formed at an outer edge of the separator. The film member is disposed to cover the counter electrode and the counter electrode current collector and is joined inside the plurality of holes, at least including the outer edge of the separator.

### BRIEF DESCRIPTION OF THE DRAWINGS

The above features of the present disclosure will be made clearer by the following detailed description, given referring to the appended drawings. In the accompanying drawings:

FIG. 1 shows a conceptual diagram of an overall configuration of a carbon dioxide recovery system according to a first embodiment;

FIG. 2 shows an explanatory diagram of a carbon dioxide recovery unit;

FIG. 3 shows an explanatory diagram of a configuration of an electrochemical cell in the carbon dioxide recovery unit;

FIG. 4 shows an exploded view of the electrochemical cell according the first embodiment;

FIG. 5 shows a cross-sectional view of a configuration of the electrochemical cell according the first embodiment;

FIG. 6 shows a cross-sectional view of a configuration of an electrochemical cell according a second embodiment;

FIG. 7 shows an exploded view of an electrochemical cell according a third embodiment;

FIG. 8 shows a cross-sectional view of a configuration of the electrochemical cell according the third embodiment;

FIG. 9 shows a cross-sectional view of a configuration of an electrochemical cell according a fourth embodiment; and

FIG. 10 shows a cross-sectional view a configuration of an electrochemical cell according a fifth embodiment.

### DETAILED DESCRIPTION OF THE PREFERRED EMBODIMENTS

The carbon dioxide recovery system requires the working electrode to be exposed to a mixture of gases in order to adsorb carbon dioxide onto the carbon dioxide adsorbent of the working electrode. Therefore, in JP 2018-533470 A, the working electrode current collector is formed with a gas-permeable membrane.

On the other hand, if the counter electrode is exposed to a mixture of gases, the electroactive auxiliary material of the counter electrode may be oxidized by the potential applied to the counter electrode. If the electroactive auxiliary material is oxidized, the ability of the gas to be recovered in the gas recovery system may be reduced.

In view of the above, an object of the present disclosure is to provide a gas recovery system capable of suppressing a decrease in the recovery capacity of the gas to be recovered.

A gas recovery system according to one aspect of the present disclosure is a gas recovery system that recovers a gas to be recovered from a mixed gas by electrochemical reaction, and includes an electrochemical cell and a counter electrode sealing member.

The electrochemical cell is configured by laminating a working electrode, a counter electrode, a separator, a working electrode current collector, and a counter electrode current collector. The working electrode adsorbs the gas to be recovered. The counter electrode transfers electrons to and from the working electrode. The separator is disposed between the working electrode and the counter electrode to prevent physical contact between the working electrode and the counter electrode to suppress electrical shorts from occurring. The working electrode current collector contacts the working electrode and electrically connects the working electrode to the counter electrode. The counter electrode current collector contacts the counter electrode and electrically connects the working electrode to the counter electrode. The counter electrode sealing member is disposed to cover the counter electrode and the counter electrode current collector with respect to the electrochemical cell and suppresses contact between the mixed gas and the counter electrode. The counter electrode sealing member is composed of a film member formed of a material that is impermeable to the mixed gas. A plurality of holes penetrating the separator are formed at an outer edge of the separator. The film member is disposed to cover the counter electrode and the counter electrode current collector and is joined inside the plurality of holes, at least including the outer edge of the separator.

According to the gas recovery system, the contact between the mixed gas and the counter electrode is suppressed by the counter electrode sealing member positioned against the electrochemical cell. As a result, the gas recovery system can prevent the counter electrode from being oxidized, thereby it is possible to suppress a decrease in the recovery capacity of the gas recovery system for the gas to be recovered.

The following is a description of several embodiments of implementing the present disclosure with reference to the drawings. In each embodiment, parts corresponding to items described in the preceding embodiments may be given the same reference numerals to omit redundant explanations. If only a part of the configuration is described in each embodiment, other embodiments described earlier may be applied to the other parts of the configuration. Not only combinations of parts that are specifically indicated as combinable in each embodiment, but also partial combinations of embodiments without being explicitly indicated are possible if no particular obstacle to the combination arises.

### First Embodiment

The first embodiment in the present disclosure is described with reference to the drawings. The first embodiment applies a gas recovery system in the present disclosure to a carbon dioxide recovery system 1 that separates and recovers carbon dioxide from a mixed gas containing carbon dioxide. Thus, the gas to be recovered in the present embodiment is carbon dioxide.

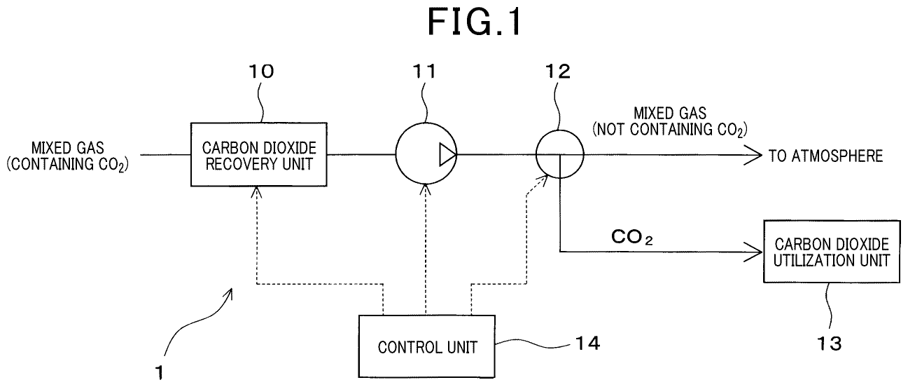

As shown in FIG. 1, the carbon dioxide recovery system 1 of the first embodiment includes a carbon dioxide recovery unit 10, a pump 11, a flow switching valve 12, a carbon dioxide utilization unit 13, and a control unit 14.

The carbon dioxide recovery unit 10 separates and recovers carbon dioxide from the mixed gas. The mixed gas may be atmospheric air or exhaust gas from an internal combustion engine. The mixed gas also contains gases other than carbon dioxide. The carbon dioxide recovery unit 10 is supplied with a mixed gas. The carbon dioxide recovery unit 10 discharges the mixed gas after the carbon dioxide has been removed, or the recovered carbon dioxide. The detailed configuration of the carbon dioxide recovery unit 10 is described below.

An inlet side of the pump 11 is connected to an outlet of the carbon dioxide recovery unit 10. The pump 11 sucks the mixed gas after the carbon dioxide has been removed or the recovered carbon dioxide from the carbon dioxide recovery unit 10. Further, the mixed gas is supplied to the carbon dioxide recovery unit 10 by the suction action of the pump 11.

Note that although the pump 11 is disposed downstream of the carbon dioxide recovery unit 10 in the gas flow direction in the present embodiment, the pump 11 may also be disposed upstream of the carbon dioxide recovery unit 10 in the gas flow direction.

An inlet side of the flow switching valve 12 is connected to a discharge outlet of the pump 11. The flow switching valve 12 is a three-way valve that switches a flow path of the gas flowing out of the carbon dioxide recovery unit 10. One outlet of the flow switching valve 12 is connected to the atmosphere, and another outlet of the flow switching valve 12 is connected to the carbon dioxide utilization unit 13. Therefore, the flow switching valve 12 switches the flow path between the gas flowing out of the carbon dioxide recovery unit 10 to the atmosphere side and the gas flowing out of the carbon dioxide recovery unit 10 to the carbon dioxide utilization unit 13.

The carbon dioxide utilization unit 13 is a device that utilizes carbon dioxide. The carbon dioxide utilization unit 13 may be, for example, a storage tank that stores carbon dioxide or a converter that converts carbon dioxide into fuel. The converter is a device that converts carbon dioxide into methane or other hydrocarbon fuels. Hydrocarbon fuels may be gaseous fuels at ambient temperature and pressure or liquid fuels at ambient temperature and pressure.

The control unit 14 is composed of a well-known microcomputer including a CPU, ROM, RAM, etc., and its peripheral circuits. The control unit 14 performs various calculations and processing based on the control program stored in the ROM, and controls the operation of various control target devices connected to the output side. More specifically, the control unit 14 of the present embodiment controls the operation of the carbon dioxide recovery unit 10, the pump 11, and the flow switching valve 12.

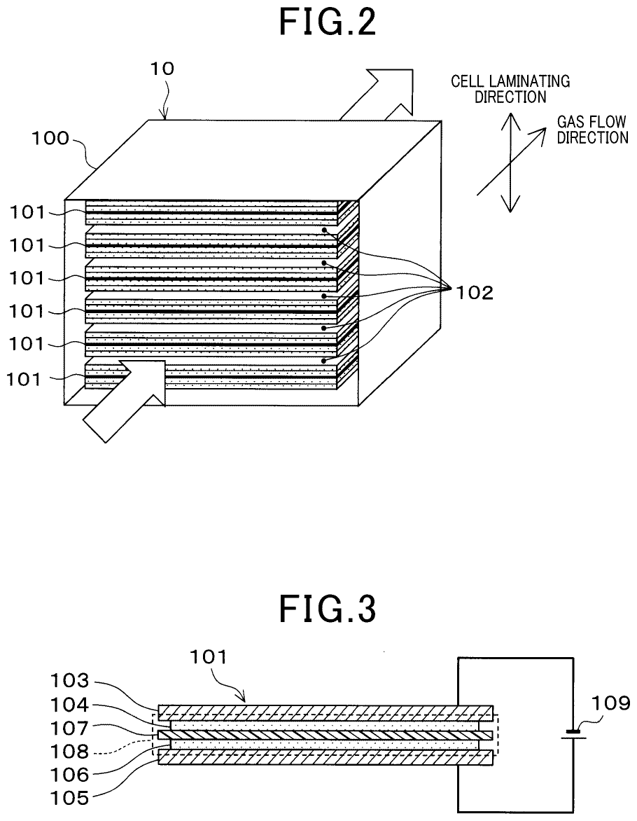

Next, the configuration of the carbon dioxide recovery unit 10 used in the carbon dioxide recovery system 1 is explained using FIGS. 2 and 3. As shown in FIG. 2, the carbon dioxide recovery unit 10 has a housing 100 and a plurality of electrochemical cells 101. The housing 100 of the present embodiment is formed by metallic material. The housing 100 may be formed of a resin material.

The housing 100 has a gas inlet and a gas outlet. The gas inlet is an opening that allows the mixed gas to flow into the housing 100. The gas outlet is an opening through which the mixed gas after the carbon dioxide has been removed, or the recovered carbon dioxide, can flow out of the housing 100.

The electrochemical cell 101 adsorbs carbon dioxide through an electrochemical reaction to separate and recover carbon dioxide from the mixed gas. The electrochemical cell 101 also desorbs carbon dioxide through an electrochemical reaction and releases the adsorbed carbon dioxide. The plurality of electrochemical cells 101 are accommodated in the housing 100.

The electrochemical cell 101 is formed as a rectangular flat plate. The plurality of electrochemical cells 101 are laminated and arranged at regular intervals inside the housing 100 so that their plate surfaces are parallel to each other.

A plurality of gas flow paths 102 are formed between adjacent electrochemical cells 101 to distribute the mixed gas that flows from the gas inlet. Thus, the flow direction of the mixed gas is parallel to the plate surfaces of the electrochemical cells 101 and perpendicular to the laminating direction of the plurality of electrochemical cells 101.

As shown in FIG. 3, the electrochemical cell 101 has a working electrode current collector 103, a working electrode 104, a counter electrode current collector 105, a counter electrode 106, a separator 107, and an electrolyte layer 108. The working electrode current collector 103, the working electrode 104, the counter electrode current collector 105, the counter electrode 106, and the separator 107 are all formed as rectangular flat plates.

The electrochemical cell 101 is formed as a laminate in which the working electrode current collector 103, the working electrode 104, the counter electrode current collector 105, the counter electrode 106, and the separator 107 are laminated. The laminating direction in which the working electrode current collector 103, etc. are laminated in the individual electrochemical cells 101 and the laminating direction in which the plurality of electrochemical cells 101 are laminated inside the housing 100 coincide.

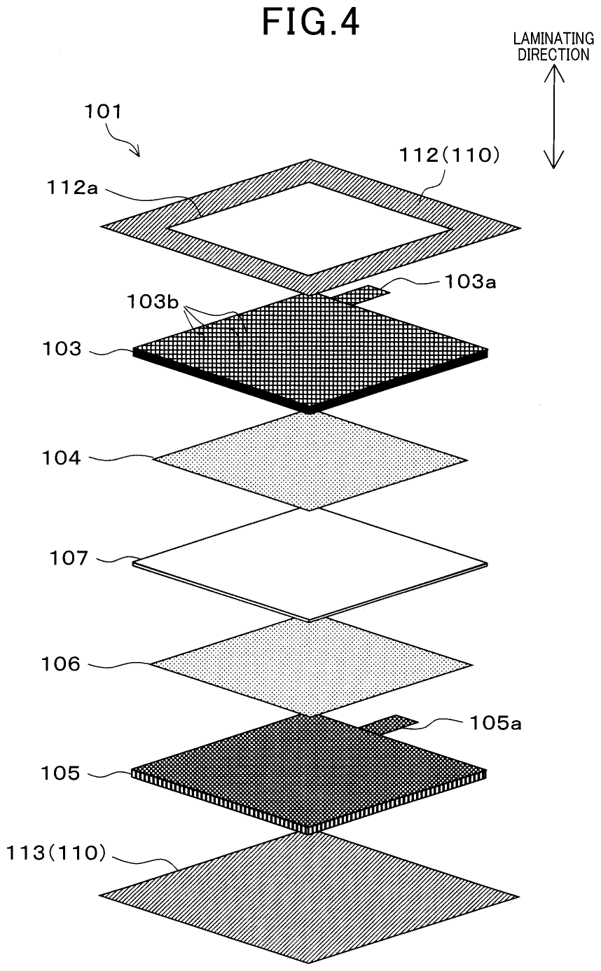

The working electrode current collector 103 is a conductive member that contacts the working electrode 104 and electrically connects the working electrode 104 to the counter electrode 106. As shown in FIG. 4, etc., the working electrode current collector 103 has a working electrode side lead out 103a, and the working electrode current collector 103 is connected to a power supply 109 through the working electrode side lead out 103a.

In addition, a first flat surface of the working electrode current collector 103 is exposed to the mixed gas. A second flat surface of the working electrode current collector 103 is in contact with the working electrode 104. The working electrode current collector 103 has a plurality of working electrode openings 103b to expose the mixed gas on the first flat surface to the working electrode 104 on the second flat surface.

Specifically, the working electrode current collector 103 in the present embodiment is made of a porous metal material. Thus, the working electrode openings 103b in the present embodiment are formed by a plurality of voids formed inside the working electrode current collector 103 that are connected to each other. A metal porous material with a porosity of 50% or more may be employed as the working electrode current collector 103. The porosity is defined as the ratio of the volume of voids to the apparent volume.

The working electrode 104 can adsorb and collect carbon dioxide from the mixed gas and desorb and release the collected carbon dioxide. The working electrode 104 has a carbon dioxide adsorbent, a conductive auxiliary, and a binder. The carbon dioxide adsorbent, the conductive auxiliary, and the binder are used in a form of a mixture. More specifically, fine grains of carbon dioxide adsorbent and fine grains of conductive auxiliary are used, held together by the binder.

The carbon dioxide adsorbent is an electroactive species that adsorbs carbon dioxide by receiving electrons and desorbs the adsorbed carbon dioxide by releasing electrons. For example, polyanthraquinone may be used as a carbon dioxide adsorbent.

The conductive auxiliary forms a conductive path to the carbon dioxide adsorbent. Carbon materials such as carbon nanotubes, carbon black, graphene, etc. may be used as a conductive auxiliary.

The binder is a binding agent that holds the carbon dioxide adsorbent and the conductive auxiliary. For example, conductive resins of polymeric polymers may be used as a binder. As the conductive resins, epoxy resins containing Ag, etc. as conductive fillers, and organic materials such as polytetrafluoroethylene (PTFE), polyvinylidene fluoride (PVDF), and other fluoropolymers may be used.

The counter electrode current collector 105 is a conductive material that contacts the counter electrode 106 and electrically connects the working electrode 104 to the counter electrode 106. As shown in FIG. 4, etc., the counter electrode current collector 105 has a counter electrode side lead out 105a, and the counter electrode current collector 105 is connected to the power supply 109 through the counter electrode side lead out 105a. In addition, a first flat surface of the counter electrode current collector 105 is exposed to the mixed gas. A second flat surface of the counter electrode current collector 105 is in contact with the counter electrode 106.

The counter electrode 106 transfers electrons to and from the working electrode 104 as the carbon dioxide adsorbent adsorbs or desorbs carbon dioxide. The counter electrode 106 has an electroactive auxiliary material, a conductive auxiliary, and a binder. The electroactive auxiliary material, the conductive auxiliary, and the binder are used in a form of a mixture. More specifically, in the present embodiment, fine grains of electroactive auxiliary material and fine grains of conductive auxiliary are used, held together by the binder.

The basic composition of the conductive auxiliary and the binder of the counter electrode 106 is the same as that of the conductive auxiliary and the binder of the working electrode 104. The electroactive auxiliary material is a supplementary electroactive species that transfers electrons to and from the carbon dioxide adsorbent in the working electrode 104 and is an active material with redox properties. As the active materials, organic compounds with x-bonds, transition metal compounds that take on multiple oxidation numbers, and metal complexes that enable electron transfer by changing the valence of metal ions may be used.

Such metal complexes include cyclopentadienyl metal complexes such as ferrocene, nickelocene, and cobaltocene, or porphyrin metal complexes. These metal complexes may be polymers or monomers.

The separator 107 is disposed between the working electrode 104 and the counter electrode 106, separating the working electrode 104 from the counter electrode 106. The separator 107 is an insulating ion permeable membrane that prevents physical contact between the working electrode 104 and the counter electrode 106 to suppress electrical shorts from occurring and allows ions to pass through. Cellulose membranes, polymers, and polymer-ceramic composites may be used as a separator 107.

The electrolyte layer 108 is an immersion layer in which the working electrode 104, the separator 107, and the counter electrode 106 are immersed. For example, an ionic liquid may be employed as an electrolyte layer 108. The ionic liquids are liquid salts that are nonvolatile at room temperature and pressure.

Further, the power supply 109 is connected to the working electrode current collector 103 and the counter electrode current collector 105 of the electrochemical cell 101. The power supply 109 can apply a predetermined voltage to the working electrode 104 and the counter electrode 106 to change the potential difference between the working electrode 104 and the counter electrode 106. The working electrode 104 is a negative electrode and the counter electrode 106 is a positive electrode.

The electrochemical cell 101 operates in a carbon dioxide recovery mode in which carbon dioxide is recovered by the working electrode 104 and in a carbon dioxide release mode in which carbon dioxide is released from the working electrode 104 by changing the potential difference between the working electrode 104 and the counter electrode 106. The carbon dioxide recovery mode is a charging mode that charges the electrochemical cell 101, while the carbon dioxide release mode is a discharge mode that discharges the electrochemical cell 101.

Specifically, in the carbon dioxide recovery mode, a first voltage V1 is applied between the working electrode 104 and the counter electrode 106, and electrons are supplied from the counter electrode 106 to the working electrode 104. At the first voltage V1, the working electrode potential is smaller than the counter electrode potential. The first voltage V1 may be in a range of 0.5 to 2.0 V, for example.

In the carbon dioxide release mode, a second voltage V2 is applied between the working electrode 104 and the counter electrode 106, and electrons are supplied from the working electrode 104 to the counter electrode 106. The second voltage V2 is different from the first voltage V1. The second voltage V2 may be any voltage lower than the first voltage V1, and the magnitude relationship between the working electrode potential and the counter electrode potential is not limited. That is, in the carbon dioxide release mode, the working electrode potential may be smaller than the counter electrode potential, the working electrode potential may be equal to the counter electrode potential, or the working electrode potential may be larger than the counter electrode potential.

Next, the operation of the carbon dioxide recovery system 1 is described. As described above, the carbon dioxide recovery system 1 operates by alternating between the carbon dioxide recovery mode and the carbon dioxide release mode. The operation of the carbon dioxide recovery system 1 is controlled by the control unit 14.

First, the operation of the carbon dioxide recovery system 1 in the carbon dioxide recovery mode is described. In the carbon dioxide recovery mode, the pump 11 is activated. This supplies the mixed gas to the carbon dioxide recovery unit 10. In the carbon dioxide recovery unit 10, the voltage applied between the working electrode 104 and the counter electrode 106 of the electrochemical cell 101 is the first voltage V1. This allows simultaneous electron donation of the electroactive auxiliary material of the counter electrode 106 and electron acceptance by the carbon dioxide adsorbent of the working electrode 104.

The carbon dioxide adsorbent in the working electrode 104, which receives electrons from the counter electrode 106, has a higher carbon dioxide binding capacity and binds and adsorbs the carbon dioxide in the mixed gas. This allows the carbon dioxide recovery unit 10 to recover carbon dioxide from the mixed gas. After the carbon dioxide has been removed, the mixed gas is discharged from the carbon dioxide recovery unit 10.

Then, in the carbon dioxide recovery mode, the flow switching valve 12 switches to a flow path that allows the mixed gas discharged from the carbon dioxide recovery unit 10 to flow out to the atmosphere. The mixed gas discharged from the carbon dioxide recovery unit 10 is then discharged to the atmosphere.

The operation of the carbon dioxide recovery system 1 during the carbon dioxide release mode is described next. In the carbon dioxide release mode, the pump 11 is stopped. This stops the supply of mixed gas to the carbon dioxide recovery unit 10. In the carbon dioxide recovery unit 10, the voltage applied between the working electrode 104 and the counter electrode 106 of the electrochemical cell 101 is the second voltage V2. This allows simultaneous electron donation by the carbon dioxide adsorbent in the working electrode 104 and electron seeking by the electroactive auxiliary material in the counter electrode 106.

The carbon dioxide adsorbent in the working electrode 104 releases electrons and enters an oxidized state. The carbon dioxide adsorbent decreases the binding of carbon dioxide and desorbs and releases carbon dioxide. Carbon dioxide released from the carbon dioxide adsorbent is discharged from the carbon dioxide recovery unit 10.

In the carbon dioxide release mode, the flow switching valve 12 switches the flow path of carbon dioxide discharged from the carbon dioxide recovery unit 10 to flow out to an inlet side of the carbon dioxide utilization unit 13. Carbon dioxide discharged from the carbon dioxide recovery unit 10 is then supplied to the carbon dioxide utilization unit 13.

As described above, the carbon dioxide recovery system 1 in the present embodiment allows carbon dioxide to be recovered from the mixed gas and the recovered carbon dioxide to be used effectively.

Next, a manufacturing method of the electrochemical cell 101 described above will be explained. The manufacturing method of the electrochemical cell 101 of the present embodiment has a current collector attachment process on the working electrode side, in which the working electrode 104 is attached to the working electrode current collector 103, and a current collector attachment process on the counter electrode side, in which the counter electrode 106 is attached to the counter electrode current collector 105. The process of attaching current collectors on the working electrode side and the counter electrode side may be performed separately.

The process of attaching current collectors on the working electrode side and the counter electrode side are basically equivalent. First, the process of attaching the current collector on the working electrode side is described. In the process of attaching the current collector on the working electrode side, a preparation process, a coating process, a drying process, and a peeling process are performed. In the preparation process, the working electrode current collector 103 is placed on a release paper placed on a flat surface. The release paper is a release paper used in a molding process for materials that exhibit temporary adhesion.

In the coating process, the working electrode 104, which is a paste made by mixing the carbon dioxide adsorbent, the conductive auxiliary, and the binder, is applied to a top surface, that is, the opposite side of the release paper, of the working electrode current collector 103 after the preparation process by screen printing or other means. As a result, the working electrode 104, which is in paste form, enters not only the top surface of the working electrode current collector 103 but also the inside of the working electrode openings 103b.

In the drying process, the working electrode 104 coated on the working electrode current collector 103 after the coating process is dried. This hardens the working electrode 104. Thus, the working electrode 104 is formed by solidifying fine grains of the carbon dioxide adsorbent and fine grains of the conductive auxiliary together with the binder. In the drying process, the working electrode current collector 103 and the working electrode 104 may be heated to speed up the drying process. In addition, the working electrode current collector 103 and the working electrode 104 may be placed in a low-pressure environment.

In the peeling process, the release paper is peeled off from the working electrode current collector 103. In the peeling process, when the release paper is peeled off from the working electrode current collector 103, parts of the working electrode 104 may be peeled off together with the release paper, and the part of the working electrode 104 may be missing. Therefore, in the peeling process, it is desirable to peel off the release paper so that no defects are formed on the working electrode 104.

The above process attaches the working electrode 104 to the working electrode current collector 103 in the process of attaching the current collector on the working electrode side. The same preparation, coating, drying, and peeling processes are executed in in the process of attaching the current collector on the counter electrode side, where the counter electrode 106 is attached to the counter electrode current collector 105.

Then, a lamination process is performed in which the working electrode current collector 103 and the working electrode 104 attached by the process of attaching current collectors on the working electrode side, and the counter electrode current collector 105 and counter electrode 106 attached by the process of attaching current collectors on the counter electrode side are laminated together by interposing the separator 107. In the lamination process, the surfaces of the working electrode 104 and the counter electrode 106 are laminated together so that they are in contact with the separator 107, as is evident from FIGS. 3 and 4.

Thereafter, the power supply 109 is connected to the working electrode side lead out 103a of the working electrode current collector 103 and the counter electrode side lead out 105a of the counter electrode current collector 105. This produces the electrochemical cell 101.

In the carbon dioxide recovery system 1 of the first embodiment, a counter electrode sealing member 110 is disposed for the electrochemical cell thus produced. In the first embodiment, a film member 111 made of a gas-impermeable material is used as the counter electrode sealing member 110.

Note that when placing the film member 111 on the electrochemical cell 101, the placement of the working electrode side film 112 and the counter electrode side film 113 is performed in a reduced pressure environment or in an inert gas environment.

Specifically, as shown in FIG. 4, a working electrode side film 112 and a counter electrode side film 113 are disposed for the electrochemical cell 101 as film members 111. Then, the working electrode side film 112 and the counter electrode side film 113 are disposed to surround the electrochemical cell 101 so as to accommodate the electrochemical cell 101 inside, as shown in FIG. 5.

The working electrode side film 112 is a film member 111 that is disposed to cover the working electrode side of the electrochemical cell 101. The working electrode side film 112 is disposed so as to adhere to the surfaces of the working electrode current collector 103 and the working electrode 104 in the electrochemical cell 101.

The working electrode side film 112 is formed larger than an area of the working electrode side of the electrochemical cell 101, and has an opening 112a in its central portion. The opening 112a in the working electrode side film 112 is open in the equivalent size as the working electrode 104 and is formed to expose the mixed gas to the working electrode 104.

On the other hand, the counter electrode side film 113 is a film member 111 that is disposed to cover the counter electrode side of the electrochemical cell 101. The counter electrode side film 113 is disposed so as to adhere to the surface of the counter electrode current collector 105 and the counter electrode 106 in the electrochemical cell 101.

Further, an outer edge of the working electrode side film 112 is bonded to an outer edge of the counter electrode side film 113 over the entire circumference. As a result, the electrochemical cell 101 is placed inside the space composed of the working electrode side film 112 and the counter electrode side film 113, as shown in FIG. 5. Since it is composed of the gas-impermeable working electrode side film 112 and the counter electrode side film 113, the space where the electrochemical cell 101 is disposed is difficult for mixed gases to flow out and in, except for the opening 112a.

Therefore, according to the first embodiment, by covering the electrochemical cell 101 with the counter electrode sealing member 110 composed of the working electrode side film 112 and the counter electrode side film 113, the contact of the mixed gas to the counter electrode current collector 105 and the counter electrode 106 may be suppressed.

It is now to consider a case where a mixed gas containing oxygen comes into contact with the counter electrode 106. When the mixed gas contains oxygen, reactive oxygen species such as superoxide are generated when the oxygen in contact with the counter electrode 106 receives electrical energy.

Such reactive oxygen species readily oxidize electroactive auxiliary materials and binders formed by organic processing materials among the counter electrode 106. Then, if the electroactive auxiliary material is oxidized, the ability of the electroactive auxiliary material to transfer electrons is reduced. In addition, if the binder is oxidized, the electroactive auxiliary material cannot be heed. As a result, the ability to recover carbon dioxide at the working electrode 104 may be reduced.

In this regard, in the carbon dioxide recovery system 1 of the first embodiment, the electrochemical cell 101 is surrounded by the working electrode side film 112 and the counter electrode side film 113 as the counter electrode sealing member 110, making it difficult to expose the counter electrode 106 to the mixed gas. Therefore, the electroactive auxiliary materials and binders of the counter electrode 106 are prevented from being oxidized, and the recovery capacity of the gas to be recovered in the carbon dioxide recovery system 1 may be suppressed from being reduced.

It should be noted that the following points should be considered when selecting materials that may be used as film members 111. First, in the first embodiment, the outer edges of the working electrode side film 112 and the counter electrode side film 113 are bonded, so the outer edges must have materials or properties corresponding to the sealing method at the outer edges.

For example, when sealing the outer edge by thermocompression (hot plate welding), laser welding, ultrasonic welding, etc., the product must have thermoplasticity, and a configuration with a surface layer or film of polypropylene, nylon, polyvinyl chloride, etc. may be adopted.

In addition, when sealing the outer periphery by bonding with an adhesive, it is desirable for the film member 111 to have good wettability for the adhesive (i.e., high surface energy) or to have a rough surface. For example, laser blasting, plasma treatment, etc. may be used to create conditions suitable for bonding by adhesives. The configuration with a surface layer or film of polyvinyl chloride, nylon, polyethylene terephthalate, etc. may be made suitable for bonding by adhesives.

Then, as mentioned above, the film member 111 must be gas impermeable. In other words, it is desirable for the film member 111 to be made of a material or have a structure that has gas barrier properties. For example, the film member 111 may be composed of any of the following: a metallic vapor deposition layer such as aluminum or copper, a metallic foil layer such as aluminum, or an impermeable resin layer such as polyvinylidene chloride.

As explained above, according to the carbon dioxide recovery system 1 of the first embodiment, the electrochemical cell 101 may be covered by the counter electrode sealing members 110, which are the working electrode side film 112 and the counter electrode side film 113, so that the counter electrode 106 is less exposed to the mixed gas. Therefore, the electroactive auxiliary materials and binders of the counter electrode 106 are prevented from being oxidized, and the recovery capacity of the gas to be recovered in the carbon dioxide recovery system 1 may be suppressed from being reduced in the carbon dioxide recovery system 1

### Second Embodiment

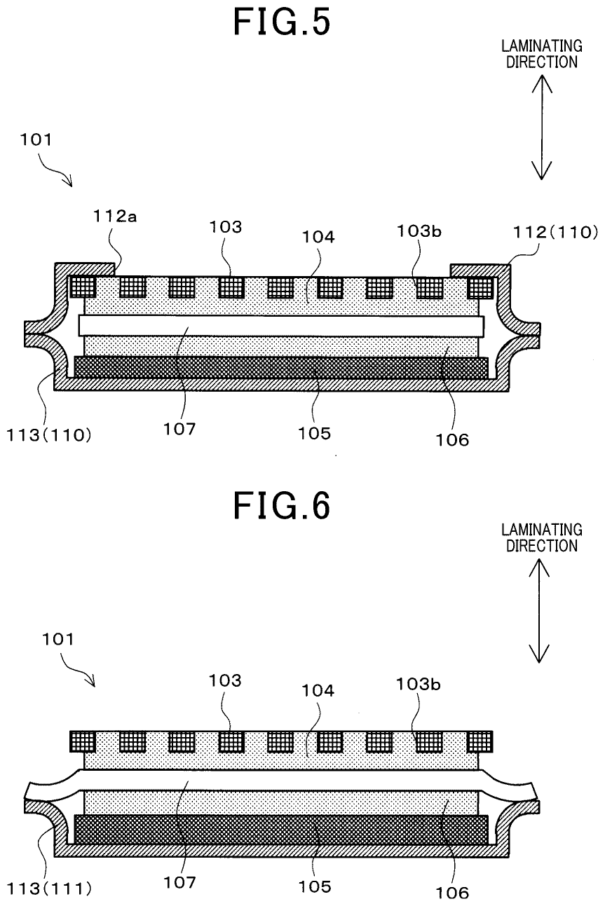

Next, the second embodiment, which differs from the embodiment described above, is described with reference to FIG. 6. In the second embodiment, the manner in which a film member 111, which is disposed as a counter electrode sealing member 110, is disposed with respect to an electrochemical cell 101 is different. The other basic configuration, etc., is the same as in the above-mentioned embodiment, and therefore will not be described again.

In a carbon dioxide recovery system 1 of the second embodiment, the electrochemical cell 101 is constituted by laminating a working electrode current collector 103, a working electrode 104, a separator 107, a counter electrode 106, and a counter electrode current collector 105, in the same order as in the embodiment described above.

As shown in FIG. 6, for the electrochemical cell 101 of the second embodiment, a counter electrode side film 113, which is the film member 111, is disposed as the counter electrode sealing member 110. The separator 107 in the second embodiment is made of a material capable of being welded to the counter electrode side film 113 and is configured to have a size larger than the counter electrode current collector 105 and the counter electrode 106. Thus, in the electrochemical cell 101 of the second embodiment, an outer edge of the separator 107 is disposed outside an outer edge of the counter electrode current collector 105 and the counter electrode 106.

The counter electrode side film 113 of the second embodiment is disposed to cover the counter electrode side of the electrochemical cell 101 and adheres to surfaces of the counter electrode current collector 105 and the counter electrode 106. An outer edge of the counter electrode side film 113 is bonded by welding to the outer edge of the separator 107 over the entire circumference.

It should be noted that the method of bonding the counter electrode side film 113 to the separator 107 is not limited to welding, but various methods such as fusion, chemical bonding, and physical bonding may be employed. In addition, other configuration may be used to bond the counter electrode side film 113 to the separator 107, and for example, the counter electrode side film 113 and separator 107 may be bonded via an adhesive. Further, the properties, etc. required as the constituent material of the counter electrode side film 113 are the same as in the first embodiment.

As shown in FIG. 6, in the second embodiment, the counter electrode side film 113, which is gas impermeable, is disposed to cover the counter electrode current collector 105 and the counter electrode 106 and is bonded to the outer edge of the separator 107. Therefore, the mixed gas does not flow into the space between the separator 107 and the counter electrode side film 113. In addition, in the second embodiment, the bonding of the counter electrode side film 113 to the separator 107 is performed under reduced pressure or in an inert gas environment. Therefore, the space between the separator 107 and the counter electrode side film 113 does not contain any mixed gas from the initial state.

According to the carbon dioxide recovery system 1 of the second embodiment, the counter electrode current collector 105 and the counter electrode 106 are divided by the counter electrode side film 113 and the separator 107 to prohibit contact of the mixed gas to the counter electrode 106. Therefore, the electroactive auxiliary materials and binders of the counter electrode 106 are prevented from being oxidized, and the recovery capacity of the gas to be recovered in the carbon dioxide recovery system 1 may be suppressed from being reduced in the carbon dioxide recovery system 1 in the carbon dioxide recovery system 1 of the second embodiment.

As explained above, according to the carbon dioxide recovery system 1 of the second embodiment, when the counter electrode current collector 105 and the counter electrode 106 are partitioned at the separator 107 and the counter electrode side film 113, it is possible to obtain the effects from the configuration and operation common to the above-mentioned embodiment.

As shown in FIG. 6, by bonding the counter electrode side film 113 to the separator 107, the counter electrode current collector 105 and the counter electrode 106 may be isolated from the mixed gas, thus reducing the number of parts required to prevent deterioration of the counter electrode 106 and the resulting reduction in the ability to collect the gas to be recovered.

### Third Embodiment

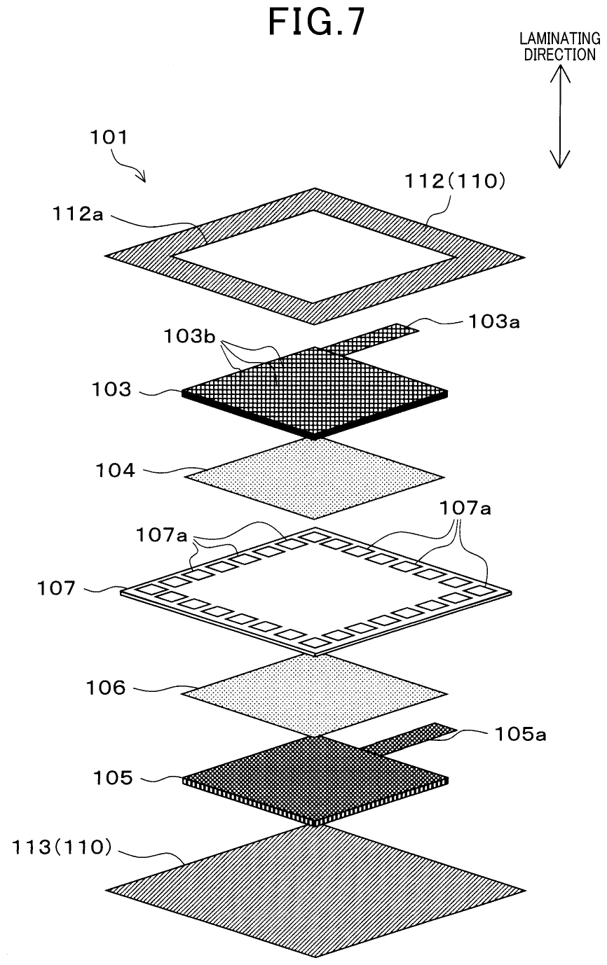

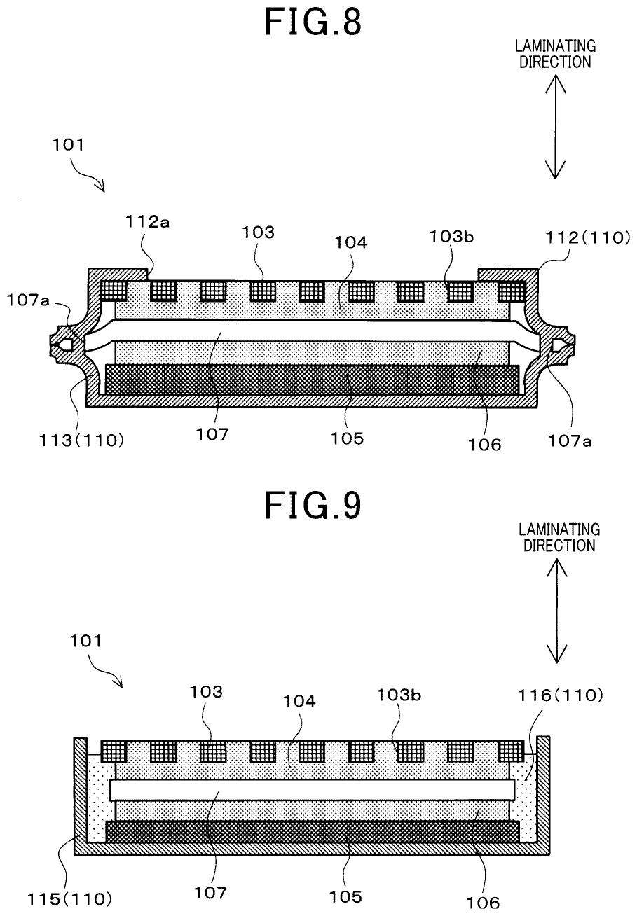

Next, the third embodiment, which differs from the embodiments described above, is described with reference to FIGS. 7 and 8. In the third embodiment, a working electrode side film 112 and a counter electrode side film 113 are used as a counter electrode sealing member 110 to prevent deterioration of a counter electrode 106 and at the same time ensure adhesion of the components of an electrochemical cell 101. The other basic configuration, etc., is the same as in the above-mentioned embodiment, and therefore will not be described again.

As shown in FIGS. 7 and 8, in a carbon dioxide recovery system 1 of the third embodiment, the electrochemical cell 101 is composed of layers of a working electrode current collector 103, a working electrode 104, a separator 107, a counter electrode 106, and a counter electrode current collector 105, in the same order as in the embodiments described above.

The separator 107 of the electrochemical cell 101 of the third embodiment has a plurality of holes 107a. In the separator 107 of the third embodiment, the plurality of holes 107a are disposed along an outer edge of the separator 107 and penetrate the separator 107 in the thickness direction thereof.

The separator 107 is formed in a size larger than the working electrode current collector 103, the working electrode 104, the counter electrode current collector 105, and the counter electrode 106. Then, the plurality of holes 107a are formed so that they are disposed outside outer edges of each of the working electrode current collector 103, the working electrode 104, the counter electrode current collector 105, and the counter electrode 106.

It should be noted that although a material having weldability to the film member 111 is employed as the material constituting the separator 107 in the second embodiment, weldability to a film member 111 is not required in the third embodiment. In the third embodiment, the separator 107 may be made of various materials provided that the materials can prevent physical contact between the working electrode 104 and the counter electrode 106 and suppress electrical shorts.

As shown in FIGS. 7 and 8, for the electrochemical cell 101 of the third embodiment, a working electrode side film 112 and a counter electrode side film 113, as the film members 111, are disposed as aa counter electrode sealing member 110.

The working electrode side film 112 is a film member 111 that is disposed to cover the working electrode side of the electrochemical cell 101, as in the embodiments described above. The working electrode side film 112 is disposed so as to adhere to surfaces of the working electrode current collector 103 and the working electrode 104 in the electrochemical cell 101.

The working electrode side film 112 is formed larger than an area of the working electrode side of the electrochemical cell 101, and has an opening 112a in its central portion. The opening 112a in the working electrode side film 112 is open in the equivalent size as the working electrode 104 and is formed to expose the mixed gas to the working electrode 104.

An outer edge of the working electrode side film 112 is disposed outside of outer edges of the working electrode current collector 103, the working electrode 104, and the separator 107, as shown in FIG. 8.

Then, the counter electrode side film 113 for the third embodiment is a film member 111 disposed to cover the counter electrode side of the electrochemical cell 101. The counter electrode side film 113 is disposed so as to adhere to surfaces of the counter electrode current collector 105 and the counter electrode 106 in the electrochemical cell 101.

An outer edge of the counter electrode side film 113 is disposed outside of outer edges of the counter electrode current collector 105, the counter electrode 106, and o the separator 107, as shown in FIG. 8.

In the third embodiment, the working electrode side film 112 and the counter electrode side film 113 are bonded by welding inside the plurality of holes 107a formed in the separator 107. This fixes the relative positions of the working electrode side film 112, the counter electrode side film 113, and the separator 107. Further, in the third embodiment, the outer edge of the working electrode side film 112 and the outer edge of the counter electrode side film 113 are welded over the entire circumference outside the outer edge of the separator 107.

In other words, it is disposed to cover the counter electrode current collector 105 and the counter electrode 106 by the gas impermeable counter electrode side film 113, and is bonded to the working electrode side film 112 through the holes 107a of the separator 107. Therefore, the space between the separator 107 and the counter electrode side film 113 can prohibit the inflow of mixed gas.

It should be noted that as in the embodiments described above, the placement operation of the working electrode side film 112 and the counter electrode side film 113 on the electrochemical cell 101 is performed in a reduced pressure environment or in an inert gas environment. Therefore, the space between the separator 107 and the counter electrode side film 113 does not contain any mixed gas from the initial state.

According to the carbon dioxide recovery system 1 of the third embodiment, the counter electrode current collector 105 and the counter electrode 106 are divided by the working electrode side film 112, the counter electrode side film 113, and the separator 107 to prohibit contact of the mixed gas to the counter electrode 106. Therefore, the electroactive auxiliary materials and binders of the counter electrode 106 are prevented from being oxidized, and the recovery capacity of the gas to be recovered in the carbon dioxide recovery system 1 may be suppressed from being reduced in the carbon dioxide recovery system 1 in the carbon dioxide recovery system 1 of the third embodiment.

In addition, as shown in FIG. 8, the relative positions of the separator 107, the working electrode film 112, and the counter electrode side film 113 may be fixed because the working electrode side film 112 and the counter electrode side film 113 are welded together inside the plurality of holes 107a.

In other words, pressure may be applied in the laminating direction to the working electrode current collector 103 and the working electrode 104 between the separator 107 and the working electrode side film 112, thereby increasing the adhesiveness of the working electrode side components in the electrochemical cell 101.

Similarly, pressure may be applied in the laminating direction to the counter electrode current collector 105 and the counter electrode 106 between the separator 107 and the counter electrode side film 113, thereby increasing the adhesiveness of the counter electrode side components in the electrochemical cell 101. That is, in the carbon dioxide recovery system 1 of the third embodiment, the separator 107, the working electrode side film 112, and the counter electrode side film 113 may be used to improve the adhesiveness of the components of the electrochemical cell 101 disposed inside.

It should be noted that the properties required for the working electrode side film 112 and the counter electrode side film 113 in the third embodiment are the same as those in the embodiments described above. In the third embodiment, pressure must be applied in the laminating direction by the electrochemical cell 101 by the separator 107, the working electrode side film 112, and the counter electrode side film 113.

Therefore, the working electrode side film 112 and counter electrode side film 113 of the third embodiment should have the mechanical strength to hold the electrochemical cell 101. For example, by having a plasticizable layer such as polyethylene and a configuration that allows press molding, the working electrode side film 112 and counter electrode side film 113 may be made with mechanical strength.

As described above, according to the carbon dioxide recovery system 1 of the third embodiment, even when using the working electrode side film 112 and the counter electrode side film 113 as the counter electrode sealing member 110, it is possible to obtain the same configuration and effects as those of the embodiments described above.

In addition, in the third embodiment, the working electrode side film 112 and the counter electrode side film 113 are welded together inside the plurality of holes 107a formed in the separator 107 to maintain the relative positions of the separator 107, the working electrode side film 112, and the counter electrode side film 113. This allows pressure to be applied in the laminating direction to the electrochemical cell 101 placed inside the space composed of the working electrode side film 112 and the counter electrode side film 113, thereby improving the adhesiveness of the components of the electrochemical cell 101.

### Fourth Embodiment

Next, the fourth embodiment, which differs from the embodiments described above, is described with reference to FIG. 9. In the fourth embodiment, a housing container 115 and resin 116 are employed as a counter electrode sealing member 110. The other basic configuration, etc., is the same as in the above-mentioned embodiment, and therefore will not be described again.

As shown in FIG. 9, in a carbon dioxide recovery system 1 of the fourth embodiment, an electrochemical cell 101 is composed of layers of a working electrode current collector 103, a working electrode 104, a separator 107, a counter electrode 106, and a counter electrode current collector 105, in the same order as in the embodiments described above.

The carbon dioxide recovery system 1 of the fourth embodiment employs a housing container 115 and resin 116 as a counter electrode sealing member 110. As shown in FIG. 9, the housing container 115 is box-shaped, with one side (the top in FIG. 9) open. The housing container 115 is made of a gas-impermeable material and is formed to accommodate the electrochemical cell 101 inside.

The electrochemical cell 101 is placed inside the housing container 115. The electrochemical cell 101 is disposed so that a side of the counter electrode 106 of the electrochemical cell 101 is in contact with a bottom of the housing container 115 and a side of the working electrode 104 is exposed.

As shown in FIG. 9, in an interior of the housing container 115, the resin 116 is disposed in a space between an inner surface of the housing container 115 and the electrochemical cell 101. The resin 116 is a gas impermeable resin material and is filled into the space between the housing container 115 and the electrochemical cell 101 by resin potting.

The material or properties required for the resin 116 to be filled by resin potting include the following points. First, the resin 116 must be electrically insulating in order to encapsulate the working electrode 104 and the counter electrode 106 at the same time. In addition, in order to achieve resin potting, the resin 116 must have flowability and curability. Further, in order to keep the electrochemical cell 101 in the housing container 115, the resin 116 is adhesive to another counter electrode sealing member 110, the housing container 115. Examples of resins 116 that meet these requirements include two-component epoxy resins and two-component silicone resins.

An amount of the resin 116 filled into the interior of the housing container 115 by resin potting is determined to cover surfaces of the counter electrode 106 and the counter electrode current collector 105 of the electrochemical cell 101 disposed inside, and to keep the working electrode 104 exposed from the resin 116. By curing the resin 116 filled in the housing container 115 by resin potting, the disposition of the counter electrode sealing member 110 for the electrochemical cell 101 of the fourth embodiment is completed.

It should be noted that the placement of the electrochemical cell 101 inside the housing container 115 and the work related to resin potting inside the housing container 115 are performed in a reduced pressure environment or in an inert gas environment.

As shown in FIG. 9, the electrochemical cell 101 of the fourth embodiment will have at least the counter electrode current collector 105 and the counter electrode 106 covered by the housing container 115, which is the counter electrode sealing member 110, and the resin 116. Therefore, the space formed between the electrochemical cell 101 and the interior of the housing container 115 can prohibit the inflow of the mixed gas.

According to the carbon dioxide recovery system 1 of the fourth embodiment, the housing container 115 and the resin 116 can cover the counter electrode current collector 105 and the counter electrode 106 to prohibit contact of the mixed gas to the counter electrode 106. Therefore, the electroactive auxiliary materials and binders of the counter electrode 106 are prevented from being oxidized, and the recovery capacity of the gas to be recovered in the carbon dioxide recovery system 1 may be suppressed from being reduced in the carbon dioxide recovery system 1 of the fourth embodiment.

As explained above, according to the carbon dioxide recovery system 1 of the fourth embodiment, even when the housing container 115 is employed as the counter electrode sealing member 110, it is possible to obtain the same configuration and effects as those of the embodiments described above.

By placing the electrochemical cell 101 inside the housing container 115 and prohibiting the inflow of mixed gas to the interior of the housing container 115, the electroactive auxiliary materials and binders of the counter electrode 106 may be prevented from being oxidized.

In addition, by filling the space between the electrochemical cells 101 and the inside of the housing container 115 with the gas-impermeable resin 116, the contact of the mixed gas with the counter electrode current collector 105 and the counter electrode 106 of the electrochemical cells 101 may be reliably prohibited. Therefore, the carbon dioxide recovery system 1 of the fourth embodiment can suppress the decrease in the recovery capacity of the gas to be recovered in the carbon dioxide recovery system 1.

In the fourth embodiment, the housing container 115 as the counter electrode sealing member 110 is composed of resin, but is not limited to the present embodiment. Provided that the material comprising the housing container 115 is gas impermeable, it may be made of various materials, for example, metal may be utilized.

In addition, in the fourth embodiment, the resin 116 filled by resin potting is used as the counter electrode sealing member 110 as a member used together with the housing container 115, but is not limited to the present embodiment. Different components and methods may be employed provided that the flow of mixed gas into and out of the interior of the housing container 115 may be controlled. For example, a film member 111 having gas impermeability may be placed between an opening edge of the housing container 115 and the electrochemical cell 101 to block the flow of mixed gas into and out of the space formed between the counter electrode 106, etc. and the interior of the housing container 115.

### Fifth Embodiment

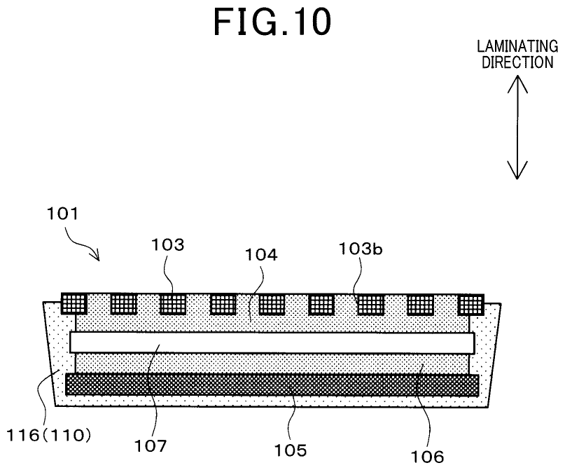

Next, the fifth embodiment, which differs from the embodiments described above, is described with reference to FIG. 10. In the fifth embodiment, a counter electrode sealing member 110 is different from the embodiments described above. The other basic configuration, etc., is the same as in the above-mentioned embodiment, and therefore will not be described again.

In the carbon dioxide recovery system 1 of the fifth embodiment, an electrochemical cell 101 is composed of layers of a working electrode current collector 103, a working electrode 104, a separator 107, a counter electrode 106, and a counter electrode current collector 105, in the same order as in the embodiments described above.

As shown in FIG. 10, a carbon dioxide recovery system 1 of the fifth embodiment employs resin 116 as a counter electrode sealing member 110. The resin 116 in the fifth embodiment is positioned against an electrochemical cell 101 by means of a mold process.

Specifically, an example of the procedure for placing the resin 116 against the electrochemical cell 101 by mold processing is described below. First, prepare a mold with a space large enough to accommodate the electrochemical cell 101. Next, the electrochemical cell 101 is placed against an interior of a space formed in the mold, with the counter electrode side being a lower surface.

Then, inject the resin 116 as a counter electrode sealing member 110 into the mold in which the electrochemical cell 101 is placed. The resin 116 is thermoplastic and gas impermeable, and is injected into the space in a fluid state. An amount of the resin 116 injected into the space is determined to cover surfaces of a counter electrode 106 and a counter electrode current collector 105 and to keep a working electrode 104 exposed from the resin 116.

After injecting a predetermined amount of the resin 116 inside the space of the mold, the mold is cooled to cure the resin 116 inside the space. After the resin 116 has cured, the electrochemical cell 101 with the resin 116 in place is retrieved from the mold, as shown in FIG. 10, and the mold process is completed.

It should be noted that the molding of the resin 116 to the electrochemical cell 101 should be performed under reduced pressure or in an inert gas environment.

In the fifth embodiment, by implementing the mold processing process described above, it is possible to obtain the electrochemical cell 101 in which the resin 116 is disposed as the counter electrode sealing member 110. Since the resin 116 covers at least the counter electrode current collector 105 and the counter electrode 106, it can prohibit contact of the mixed gas with the counter electrode 106. Therefore, the electroactive auxiliary materials and binders of the counter electrode 106 are prevented from being oxidized, and the recovery capacity of the gas to be recovered in the carbon dioxide recovery system 1 may be suppressed from being reduced in the carbon dioxide recovery system 1 in the carbon dioxide recovery system 1 of the fifth embodiment.

The material or properties required for the resin 116 used in the mold process include the following points. First, the resin 116 must be electrically insulating in order to encapsulate the working electrode 104 and the counter electrode 106 at the same time. In addition, the resin 116 must have flowability and curability in order to achieve mold processing.

Further, in order to prevent the mixed gas from coming into contact with the counter electrode 106, the resin 116 is required to have gas impermeability (i.e., gas barrier properties). Furthermore, the resin 116 must have a certain mechanical strength to hold the electrochemical cell 101 inside the molded resin 116. An example of a resin 116 that meets these conditions is an epoxy resin with silica filler.

As explained above, according to the carbon dioxide recovery system 1 of the fifth embodiment, even when the molded resin 116 is employed as the counter electrode sealing member 110, the same configuration and operation as in the embodiments described above may be achieved.

The present disclosure is not limited to the above-mentioned embodiments, but may be varied in various ways as follows to the extent not departing from the intent of the present disclosure.

In the present embodiments described above, the gas recovery system of the present disclosure is applied to a carbon dioxide recovery system 1 that recovers carbon dioxide from a mixed gas, however, the application of the gas recovery system of the present disclosure is not limited to this. The gas recovery system of the present disclosure may be applied to a system for recovering a specific type of gas other than carbon dioxide from a mixed gas. For example, nitrogen oxide gas (NOX) and sulfur oxide gas (SOx) may be employed as gases to be recovered in a gas recovery system.

In the third embodiment described above, a single opening of the same size as the working electrode 104 was employed as the opening 112a of the working electrode side film 112, however, this is not limited to this. The opening 112a is only required if the working electrode 104 is exposed to the mixed gas, and the number of openings may be multiple.

If a plurality of openings are placed with respect to the same extent as the working electrode 104, a frame section comprising opening edges of the plurality of openings will be placed within the same extent as the working electrode 104. The frame section can exert pressure in the direction of pressing the constituent materials of the electrochemical cell 101 in the laminating direction within the working electrode 104. In other words, the openings 112a of the working electrode side film 112 may be configured with multiple openings to improve the adhesion of the constituent materials in the electrochemical cell 101.

Although the present disclosure has been described in accordance with the embodiments, it is understood that the present disclosure is not limited to the embodiments or structures. The present disclosure also encompasses various variants and variations within the scope of equality. In addition, various combinations and forms, as well as other combinations and forms that include only one element, more or less, thereof, also fall within the scope and idea of the present disclosure.

What is claimed is:

1. A gas recovery system for recovering a gas to be recovered from a mixed gas by electrochemical reaction, the gas recovery system comprising:
an electrochemical cell composed of a laminated arrangement of the following:
a working electrode that adsorbs the gas to be recovered,
a counter electrode that transfers electrons to and from the working electrode,
a separator disposed between the working electrode and the counter electrode to prevent physical contact between the working electrode and the counter electrode to suppress electrical shorts from occurring,
a working electrode current collector that contacts the working electrode and electrically connects the working electrode to the counter electrode, and
a counter electrode current collector that contacts the counter electrode and electrically connects the working electrode to the counter electrode, and
a counter electrode sealing member that is disposed to cover the counter electrode and the counter electrode current collector with respect to the electrochemical cell and suppresses contact between the mixed gas and the counter electrode, wherein
the counter electrode sealing member is composed of a film member formed of a material that is impermeable to the mixed gas,
a plurality of holes penetrating the separator are formed at an outer edge of the separator, and
the film member is disposed to cover the counter electrode and the counter electrode current collector and is joined inside the plurality of holes, at least including the outer edge of the separator.
